(19) United States
(12) Patent Application Publication
(10) Pub. No.: US 2003/0206205 A1
(43) Pub. Date: Nov. 6, 2003

(54) Using a simple input device to browse through content on a graphical display

(76) Inventors: Hideya Kawahara, Mountain View, CA (US); Robert J. Rocchetti, Los Altos Hills, CA (US)

Correspondence Address: PARK, VAUGHAN & FLEMING LLP, 508 SECOND STREET, SUITE 201, DAVIS, CA, 95616, US

(21) Appl. No.: 10/138,174

(22) Filed: May 1, 2002

(51) Int. Cl. G09G 5/00

(52) U.S. Cl. 345/854; 345/805

(57) ABSTRACT

One embodiment of the present invention provides a system that supports browsing through content on a display. This display presents a graph containing nodes representing content or other objects that are coupled together by links. A “focus node” is located in a prominent position in the display, and other nodes are located in other positions. During operation, a user inputs a selection command that selects a link from the focus node that points to a selected node. In response to this selection command, the system changes the display so that the selected node becomes the focus node. This involves moving the selected node to the prominent position in the display, and rearranging the other nodes to appear in other positions.

### BACKGROUND

1. Field of the Invention

The present invention relates to user interfaces for computer systems. More specifically, the present invention relates to a method and an apparatus that uses a simple input device, such as a remote control or a game controller, to browse through content represented by nodes on a graphical display.

2. Related Art

The Internet enables users to seamlessly browse through content in countless web pages located on millions of geographically distributed machines. Most of this browsing activity takes place through browsers that manipulate web pages containing HyperText Markup Language (HMTL). These web browsers were developed years ago for use on personal computer systems.

As consumer electronics devices become more sophisticated and are increasingly networked together, it is becoming possible to perform browsing from such devices. To this end, a number of technologies have been developed to support Internet browsing from consumer electronics devices. However, these technologies have so far only attempted to adopt HTML-based browsers to consumer electronics devices.

Browsers developed for consumer electronics devices, such as cell phones or personal digital assistants (PDAs), presently allow users to navigate through content on the Internet by entering commands through a limited user input mechanism that does not include a pointing device, such as a mouse. However, these browsers are only able to display content through the extremely limited graphics capabilities that are available on such devices. Moreover, as larger numbers of consumer electronics devices are networked together, it is becoming increasingly desirable to seamlessly access content from these devices in the same manner as content is accessed from web sites on the Internet.

Other types of consumer electronics devices, such as game consoles or set top boxes, also provide a limited user input mechanism. However, unlike cell phones or PDAs, these devices provide an extremely high quality display (e.g., a wide screen television monitor) that makes it possible to display extremely high quality graphical output.

What is needed is a method and an apparatus that facilitates browsing through a limited user input mechanism, but at the same time makes use of the high quality graphics capabilities of consumer electronics devices, such as game consoles or set top boxes.

### SUMMARY

One embodiment of the present invention provides a system and a means for supporting browsing through content on a display. This display presents a graph containing nodes representing content or other objects that are coupled together by links. A “focus node” is located in a prominent position in the display, and other nodes are located in other positions. During operation, a user inputs a selection command that selects a link from the focus node that points to a selected node. In response to this selection command, the system changes the display so that the selected node becomes the focus node. This involves moving the selected node to the prominent position in the display, and rearranging the other nodes to appear in other positions.

In a variation on this embodiment, receiving the selection command involves receiving a direction command specifying a direction from the focus node. It also involves selecting a link from the focus node in the specified direction, and following the link to find the selected node. In a further variation, selecting the link involves selecting the link from a number of links in the specified direction.

In a variation on this embodiment, the focus node is located in the center of the display.

In a variation on this embodiment, the focus node is located in front of the other nodes in a three-dimensional representation of the graph that appears in the display.

In a variation on this embodiment, the system receives a command from a user to move a node associated with a piece of content under a node associated with a device. In response to this command, the system installs the piece of content on the device.

In a variation on this embodiment, changing the display so that the selected node becomes the focus node involves tilting the graph in the direction of the selected link. It can also involve tilting the selected node and the focus node more than the rest of the graph is tilted.

In a variation on this embodiment, the graph that appears in the display includes a grouping node that associates a group of nodes in the display.

In a variation on this embodiment, the graph that appears in the display includes a hiding node. Invisible nodes coupled to this hiding node remain invisible until the hiding node becomes the focus node.

In a variation on this embodiment, changing the display so that the selected node becomes the focus node involves outputting a sound that accompanies the change.

In a variation on this embodiment, when the nodes move in the display they act as if they have momentum. Moreover, the links connecting the nodes act as if they have elasticity.

In a variation on this embodiment, rearranging the other nodes involves ensuring that the other nodes remain visible in the display.

In a variation on this embodiment, a node in the display can be associated with a device, such as a personal digital assistant, a server, a camera, a compact disk (CD) player, an audio player, a video player, or an application.

In a variation on this embodiment, a node in the display can be associated with a piece of content, such as a document, an audio file, a video, a picture, or a web page.

In a variation on this embodiment, each node is represented in the display by a two-dimensional or three-dimensional icon.

### BRIEF DESCRIPTION OF THE FIGURES

FIG. 1 illustrates a device that supports browsing with a limited user input mechanism in accordance with an embodiment of the present invention.

FIG. 2 illustrates a display of a graph in accordance with an embodiment of the present invention.

FIG. 3A illustrates a graph before changing the focus node in accordance with an embodiment of the present invention.

FIG. 3B illustrates the graph while changing the focus node in accordance with an embodiment of the present invention.

FIG. 3C illustrates the graph after changing the focus node in accordance with an embodiment of the present invention.

FIG. 4 is a flow chart illustrating the process of changing the focus node in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Device that Supports Browsing

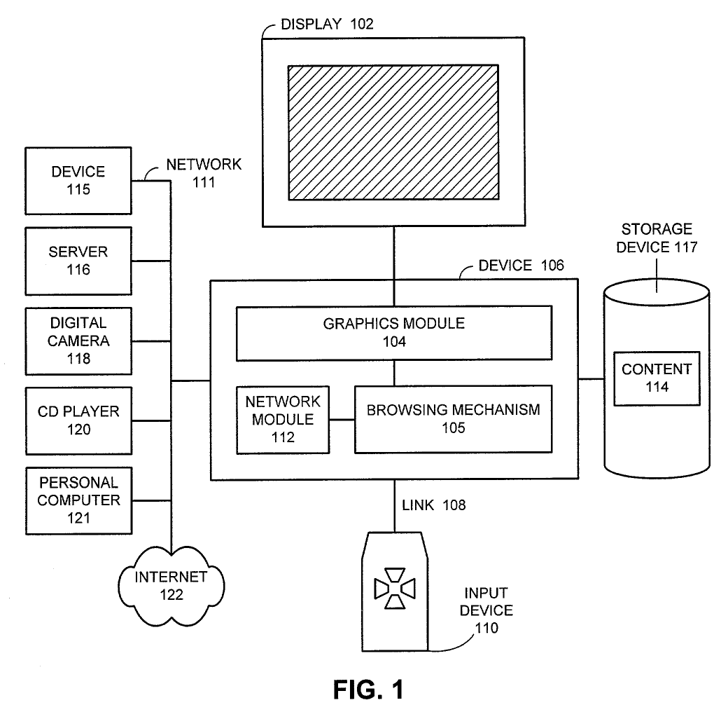

FIG. 1 illustrates a device 106 that supports browsing with a limited user input mechanism in accordance with an embodiment of the present invention. Device 106 can include any type of consumer electronics device that is associated with a display 102, such as a game controller or a set top box. Device 106 can also include any type of computer system, including, but not limited to, a computer system based on a microprocessor, a mainframe computer, a digital signal processor, a portable computing device, a personal organizer, a device controller, and a computational engine within an appliance.

Device 106 includes graphics module 104 that contains circuitry and/or code for displaying graphical objects on display 102.

Device 106 also includes network module 112 that includes circuitry and/or code that allows device 106 to communicate across a network 111. Network 111 can generally include any type of wire or wireless communication channel capable of coupling together devices and/or computing nodes. This includes, but is not limited to, a local area network, a wide area network, or a combination of networks. In one embodiment of the present invention, device 106 is coupled to, or is part of, the Internet 122.

Device 106 can communicate with other devices or computer systems across network 111. For example, in FIG. 1, device 106 can use network 111 to communicate with device 115, server 116, digital camera 118, CD player 120 and personal computer 121. Note nodes within display 102 can be associated with content and devices accessed across network 111. They can also be associated with content and devices accessed locally within device 106.

Device 106 accepts user input through input device 110. Input device 110 can be a limited user input mechanism that does not include a pointing device, such as a mouse. For example, input device 110 can be a game controller or a remote control that only has a few buttons for receiving user input. In one embodiment of the present invention, input device 110 includes direction keys that are associated with directions on display 102.

Input device 110 send commands to device 106 through link 108, which can include any type of wire-based or wireless communication channel.

Device 106 also includes (or is coupled to) storage device 117, which contains content 114. Storage device 117 can generally include any type of volatile or non-volatile storage device or memory that can be used for storing data.

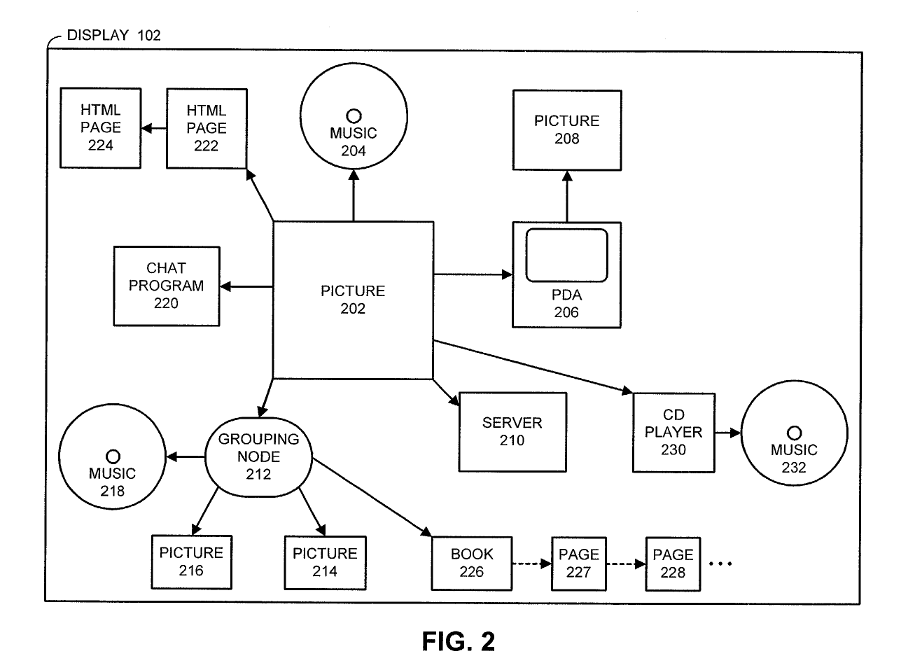

Device 106 includes a browsing mechanism 105, which allows a user to browse through various objects on display 102 by inputting simple navigation commands into input device 110. These objects can be associated with content, devices or other objects as is descried in more detail below with reference to FIGS. 2-4.

Display

FIG. 2 illustrates a display 102 containing a graph in accordance with an embodiment of the present invention. In the embodiment illustrated in FIG. 2, this graph is in the form of a tree containing nodes that are coupled together by links. Note, however, that the present invention can generally display any type of graph, and is not meant to be limited to tree structured graphs. The graph illustrated in FIG. 2 includes a number of nodes that are represented by two-dimensional or three-dimensional icons within display 102. These icons are coupled together by links as is illustrated in FIG. 2. In one embodiment of the present invention, display 102 presents a two-dimensional view of a three-dimensional arrangement of the nodes. Note that the three-dimensional location of these nodes is typically not specified by the content. Instead, browsing mechanism 105 calculates the locations of the nodes using some type of technique, such as a constraint relaxation, so that nodes are not obscured by other nodes in display 102.

Picture node 202 is the “focus node”, which appears in the center of display 102. In the three-dimensional representation, picture node 202 also appears closest to the user in display 102.

Picture node 202 is coupled a number of other nodes, which can themselves be coupled to other nodes in the graph that appears in FIG. 2. Some of the nodes represent content, such as HTML pages 222 and 224, music nodes 204, 218 and 232, picture nodes 208, 202, 216, and 214, and book node 226 (which includes page nodes 227 and 228). Other nodes represent devices, such as PDA 206, server 210 and CD player 230.

Yet other nodes, such a grouping node 212, are virtual nodes that are not directly associated with content or devices. They are used to associate other nodes with each other. For example, grouping node 212 in FIG. 2 is linked to music node 218, picture nodes 214 and 216, and book node 226. In one embodiment of the present invention, grouping node 212 represents a virtual repository through which multiple users can browse, navigate, put content into, and get content from, in the same manner as is done in a local machine. This type of grouping node allows objects representing content and devices to be shared among users, and can be implemented through peer-to-peer technology. Another type of virtual node can represent software components, such as chat program 220 or a video game (not shown).

Note that the user can change the focus node by selecting a link to follow from the focus node to another node. For example, in FIG. 2 the user can press an “up arrow” key to change the focus to music node 204. Also note that only a simple input device with direction keys is needed to select specific links.

Another type of node is a hiding node that hides a sub-tree of the graph. This sub-tree does not become visible until the hiding node becomes the focus, which can simplify the representation of the graph in the display. For example, book node 226 hides page node 227, which does not become visible until book node 226 is the focus node. Page node 227 itself hides a subsequent page node 228, and so on, for the rest of the pages of the book.

In one embodiment of the present invention, the process of changing the focus node causes motion of the nodes. For example, the nodes may tilt and shift as they are rearranged. In addition, when the user selects a node, the system can indicate the selection visually, for example by causing the selected node to vibrate three-dimensional space.

Note that the present invention can unify content browsing and content installation across the local machine, connected devices, peripherals, virtual nodes and the Internet. Each of these entities is expressed in a uniform manner as nodes in a graph within display 102. This allows a user is to navigate seamlessly through these different types of nodes.

In one embodiment of the present invention, a user can select a node that represents a piece of content and move it under a node that represents a device. This causes the content to be installed on the device, which may involve sending packets across network 111. For example, in FIG. 2, the process of moving music node 232 under CD player 230 causes content associated with music node 232 to be installed in CD player 230. This installation process does not necessarily involve simply sending a copy of the content to the device. It may involve installing key information on the device that enables the device to retrieve the content from the originating machine, the Internet or some other device.

Process of Changing the Focus Node

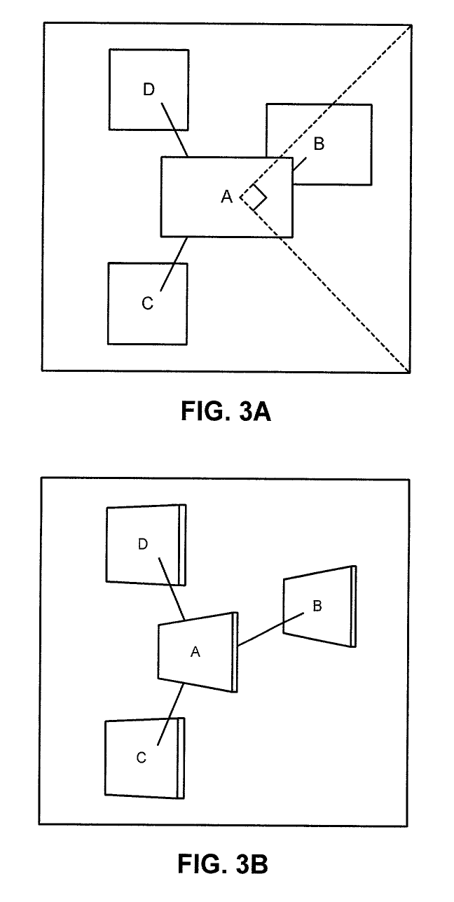

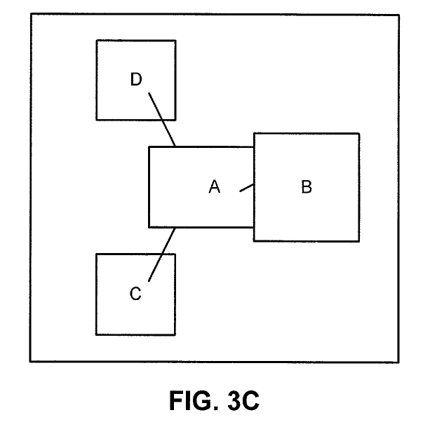

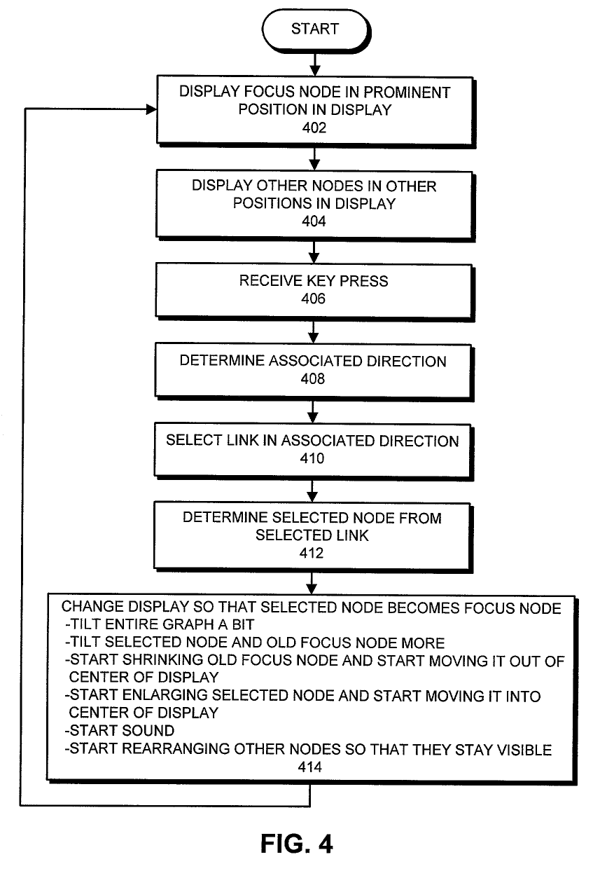

FIGS. 3A, 3B, 3C and 4 illustrate the process of changing the focus node in accordance with an embodiment of the present invention. Referring to FIG. 4, the system first displays the focus node in a prominent position in the display (step 402), and displays other nodes in other less prominent positions (step 404). For example, in FIG. 3A, focus node A is displayed in the center of the display—in front of nodes B, C and D.

Next, the system receives a key stroke (step 406) and determines a direction associated with the key stroke (step 408). For example, the key stroke can be received from a “right arrow” key.

Next, the system selects a link associated with the direction (step 410). For example, in FIG. 3A the system looks for any links emanating from the right side of node A within the angle indicated by the dashed lines. If there is more than one link, the system can select one of them randomly or through some other scheme. For example, the system can select the one that was least recently accessed so that subsequent accesses to the right side of node A cycle will through the links. The system then determines a selected node B by following the selected link (step 412).

Next, the system changes the display so that the selected node B becomes the focus node (step 414). This involves a number of actions that take place concurrently. (1) The entire graph is tilted a bit in the direction of the selected link, so that more of the graph in the selected direction behind the focus node A becomes visible. (2) Moreover, the focus node and the selected node are tilted more that the other nodes as is illustrated in FIG. 3B. (3) The system also starts shrinking the focus node and moving it out of the center of the display. (4) At the same time, the system starts enlarging the selected node and moving it to the center of the display. (5) The system also rearranges the other nodes C and D so that they remain visible within the display and are not obscured by other nodes. (6) In addition to displaying movement of the nodes, the system also starts a sound that accompanies the movement.

After selected node B become the focus node, it resides in the center of the display, and the other nodes, A, C and D, reside in less prominent positions in the display as is illustrated in FIG. 3C.

In one embodiment of the present invention, during the movement process, the nodes act as if they have momentum, and the links connecting the nodes act as if they have elasticity. This can cause various oscillations as the nodes move. The faster the nodes move, the more they tend to fly apart until they are restored by the elasticity of the links.

Note that by using the present invention a user is able to navigate through content within the display by entering simple direction-based commands, as can be supplied through a simple input device, such as a game controller or a remote control.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for browsing through content on a display, wherein the display presents a graph containing nodes representing content that are coupled together by links, the method comprising:
displaying a focus node in a prominent position in the display;
displaying other nodes in other positions in the display;
receiving a selection command that selects a link from the focus node to a selected node; and
in response to the selection command, changing the display so that the selected node becomes the focus node by,
moving the selected node to the prominent position in the display; and
rearranging the other nodes to appear in other positions in the display.

2. The method of claim 1, wherein receiving the selection command involves:
receiving a direction command specifying a direction from the focus node;
selecting the link from the focus node in the specified direction; and
following the link to find the selected node.

3. The method of claim 2, wherein selecting the link in the specified direction involves selecting the link from a number of links in the specified direction.

4. The method of claim 1, wherein the focus node is located in the center of the display.

5. The method of claim 1, wherein when the focus node is located in front of the other nodes in a three-dimensional representation of the graph that appears in the display.

6. The method of claim 1, further comprising:
receiving a command from a user to move a node associated with a piece of content under a node associated with a device; and
in response to the command, installing the piece of content on the device.

7. The method of claim 1, wherein changing the display so that the selected node becomes the focus node involves tilting the graph in the direction of the selected link.

8. The method of claim 7, wherein changing the display so that the selected node becomes the focus node involves tilting the selected node and the focus node more than the rest of the graph is tilted.

9. The method of claim 1, wherein the graph that appears in the display includes a grouping node that associates a group of nodes in the display.

10. The method of claim 1, wherein the graph that appears in the display includes a hiding node, wherein invisible nodes coupled to the hiding node remain invisible until the hiding node becomes the focus node.

11. The method of claim 1, wherein changing the display so that the selected node becomes the focus node involves outputting a sound that accompanies the change.

12. The method of claim 1, wherein when the nodes move in the display, the nodes act as if they have momentum and the links connecting the nodes act as if they have elasticity.

13. The method of claim 1, wherein rearranging the other nodes involves ensuring that the other nodes remain visible in the display.

14. The method of claim 1, wherein a node in the display can be associated with a device, such as:
a personal digital assistant;
a server;
a camera;
a compact disk (CD) player;
an audio player;
a video player; or
an application.

15. The method of claim 1, wherein a node in the display can be associated with a piece of content, such as:
a document;
an audio file;
a video;
a picture; or
a web page.

16. The method of claim 1, wherein each node is represented in the display by a two-dimensional or three-dimensional icon.

17. A computer-readable storage medium storing instructions that when executed by a computer cause the computer to perform a method for browsing through content on a display, wherein the display presents a graph containing nodes representing content that are coupled together by links, the method comprising:
displaying a focus node in a prominent position in the display;
displaying other nodes in other positions in the display;
receiving a selection command that selects a link from the focus node to a selected node; and
in response to the selection command, changing the display so that the selected node becomes the focus node by,
moving the selected node to the prominent position in the display; and
rearranging the other nodes to appear in other positions in the display.

18. The computer-readable storage medium of claim 17, wherein receiving the selection command involves:
receiving a direction command specifying a direction from the focus node;
selecting the link from the focus node in the specified direction; and
following the link to find the selected node.

19. The computer-readable storage medium of claim 18, wherein selecting the link in the specified direction involves selecting the link from a number of links in the specified direction.

20. The computer-readable storage medium of claim 17, wherein the focus node is located in the center of the display.

21. The computer-readable storage medium of claim 17, wherein when the focus node is located in front of the other nodes in a three-dimensional representation of the graph that appears in the display.

22. The computer-readable storage medium of claim 17, wherein the method further comprises:
receiving a command from a user to move a node associated with a piece of content under a node associated with a device; and
in response to the command, installing the piece of content on the device.

23. The computer-readable storage medium of claim 17, wherein changing the display so that the selected node becomes the focus node involves tilting the graph in the direction of the selected link.

24. The computer-readable storage medium of claim 23, wherein changing the display so that the selected node becomes the focus node involves tilting the selected node and the focus node more than the rest of the graph is tilted.

25. The computer-readable storage medium of claim 17, wherein the graph that appears in the display includes a grouping node that associates a group of nodes in the display.

26. The computer-readable storage medium of claim 17, wherein the graph that appears in the display includes a hiding node, wherein invisible nodes coupled to the hiding node remain invisible until the hiding node becomes the focus node.

27. The computer-readable storage medium of claim 17, wherein changing the display so that the selected node becomes the focus node involves outputting a sound that accompanies the change.

28. The computer-readable storage medium of claim 17, wherein when the nodes move in the display, the nodes act as if they have momentum and the links connecting the nodes act as if they have elasticity.

29. The computer-readable storage medium of claim 17, wherein rearranging the other nodes involves ensuring that the other nodes remain visible in the display.

30. The computer-readable storage medium of claim 17, wherein a node in the display can be associated with a device, such as:
a personal digital assistant;
a server;
a camera;
a compact disk (CD) player;
an audio player;
a video player; or
an application.

31. The computer-readable storage medium of claim 17, wherein a node in the display can be associated with a piece of content, such as:
a document;
an audio file;
a video;
a picture; or
a web page.

32. The computer-readable storage medium of claim 17, wherein each node is represented in the display by a two-dimensional or three-dimensional icon.

33. An apparatus for browsing through content, comprising:
a display mechanism that is configured to present a graph containing nodes representing content that are coupled together by links on the display;
wherein the display mechanism is configured to display a focus node in a prominent position in the display;
wherein the display mechanism is configured to display other nodes in other positions in the display;
a navigation mechanism that is configured to receive a selection command that selects a link from the focus node to a selected node; and
wherein in response to the selection command, the navigation mechanism is configured to change the display so that the selected node becomes the focus node by,
moving the selected node to the prominent position in the display; and
rearranging the other nodes to appear in other positions in the display.

34. The apparatus of claim 33, wherein the navigation mechanism is configured to:
receive a direction command specifying a direction from the focus node;
select the link from the focus node in the specified direction; and to
follow the link to find the selected node.

35. The apparatus of claim 34, wherein the navigation mechanism is configured to select the link from a number of links in the specified direction.

36. The apparatus of claim 33, wherein the display mechanism is configured to locate the focus node in the center of the display.

37. The apparatus of claim 33, wherein the display mechanism is configured to display the focus node in front of the other nodes in a three-dimensional representation of the graph that appears in the display.

38. The apparatus of claim 33, wherein the navigation mechanism is configured to:
receive a command from a user to move a node associated with a piece of content under a node associated with a device; and
in response to the command, to install the piece of content on the device.

39. The apparatus of claim 33, wherein while changing the display so that the selected node becomes the focus node, the navigation mechanism is configured to tilt the graph in the direction of the selected link.

40. The apparatus of claim 39, wherein while changing the display so that the selected node becomes the focus node, the navigation mechanism is configured to tilt the selected node and the focus node more than the rest of the graph is tilted.

41. The apparatus of claim 33, wherein the graph that appears in the display includes a grouping node that associates a group of nodes in the display.

42. The apparatus of claim 33, wherein the graph that appears in the display includes a hiding node, wherein invisible nodes coupled to the hiding node remain invisible until the hiding node becomes the focus node.

43. The apparatus of claim 33, wherein the display mechanism is configured to output a sound that accompanies the change in the display.

44. The apparatus of claim 33, wherein the navigation mechanism is configured to ensure that when the nodes move in the display, the nodes act as if they have momentum and the links connecting the nodes act as if they have elasticity.

45. The apparatus of claim 33, wherein while rearranging the other nodes, the navigation mechanism is configured to ensure that the other nodes remain visible in the display.

46. The apparatus of claim 33, wherein a node in the display can be associated with a device, such as:
a personal digital assistant;
a server;
a camera;
a compact disk (CD) player;
an audio player;
a video player; or
an application.

47. The apparatus of claim 33, wherein a node in the display can be associated with a piece of content, such as:
a document;
an audio file;
a video;
a picture; or
a web page.

48. The apparatus of claim 33, wherein each node is represented in the display by a two-dimensional or three-dimensional icon.

49. A means for browsing through content on a display, wherein the display presents a graph containing nodes representing content that are coupled together by links, comprising:
a display means for displaying a focus node in a prominent position in the display;
wherein the display means additionally displays other nodes in other positions in the display;
a selection means for receiving a selection command that selects a link from the focus node to a selected node; and
a changing means, wherein in response to the selection command, the changing means changes the display so that the selected node becomes the focus node by,
moving the selected node to the prominent position in the display; and
rearranging the other nodes to appear in other positions in the display.
